(19) United States
(12) Patent Application Publication
(10) Pub. No.: US 2019/0335241 A1
(43) Pub. Date: Oct. 31, 2019

(54) VIDEO IMAGE DISPLAY APPARATUS, VIDEO IMAGE DISPLAY SYSTEM AND VIDEO IMAGE DISPLAY METHOD

(71) Applicant: JVCKENWOOD Corporation, Yokohama-shi (JP)

(72) Inventors: Yasuo YAMADA, Yokohama-shi (JP); Takuji TERUUCHI, Yokohama-shi (JP); Toshitaka MURATA, Yokohama-shi (JP)

(73) Assignee: JVC KENWOOD Corporation

(21) Appl. No.: 16/505,393

(22) Filed: Jul. 8, 2019

Related U.S. Application Data
(63) Continuation of application No. PCT/JP2018/037108, filed on Oct. 3, 2018.

(30) Foreign Application Priority Data
Oct. 17, 2017 (JP) 2017-200756

(51) Int. Cl. H04N 21/4728; H04N 5/445; H04N 5/44; H04N 21/414; H04N 21/218; H04N 21/472; H04N 21/235

(52) U.S. Cl. CPC H04N 21/4728; H04N 5/445; H04N 5/4403; H04N 21/235; H04N 21/218; H04N 21/47217; H04N 21/41422

(57) ABSTRACT

The video image display apparatus includes: a recorded video image data acquisition unit configured to acquire recorded video image data, each being captured by a plurality of vehicles, the recorded video image data being a moving image outside the vehicle; a display control unit configured to play back one of the acquired recorded video image data and have the display apparatus display it and configured to display, in the video image of the recorded video image data being played back, location information of recorded video image data other than the recorded video image data being played back so that a user can select the location information; and a playback switching processing unit configured to switch, when a user selects the location information displayed in the video image, playback from the recorded video image data being played back to the recorded video image data corresponding to the selected location information.

### CROSS REFERENCE TO RELATED APPLICATION

This application is based upon and claims the benefit of priority from Japanese patent application No. 2017-200756, filed on Oct. 17, 2017, the disclosure of which is incorporated herein in its entirety by reference.

### BACKGROUND

The present invention relates to a video image display apparatus, a video image display system and a video image display method.

In recent years, development of technology for sharing recorded video image data each captured by image pickup means mounted on a plurality of vehicles has advanced. International Patent Publication No. WO2005/054783 discloses a navigation apparatus for measuring a current location using current location measurement means, setting a route using route setting means and designating a location using location designating means, in order to receive a video image captured at the designated location in the route from another preceding vehicle and display the received video image using display means.

### SUMMARY

According to the video image display apparatus disclosed in International Patent Publication No. WO2005/054783, it is possible to view recorded video image data captured by a predetermined vehicle which is travelling, but a user cannot conveniently handle recorded video image data each captured by a plurality of vehicles in an integrated manner.

An embodiment has been made in view of the aforementioned circumstances and aims to provide a video image display apparatus enabling a user to conveniently handle recorded video image data each captured by a plurality of vehicles in an integrated manner.

The embodiment is a video image display apparatus, including: a recorded video image data acquisition unit configured to acquire recorded video image data having time information in a predetermined time range and location information in a predetermined location range from among recorded video image data, each being captured by a plurality of vehicles, the recorded video image data being a moving image outside the vehicle; a display control unit configured to play back one of the acquired recorded video image data and have the display apparatus display the recorded video image data being played back and configured to display, in the video image of the recorded video image data being played back, location information of recorded video image data that is the acquired recorded video image data and other than the recorded video image data being played back so that a user can select the location information; and a playback switching processing unit configured to switch, when a user selects one of the location information pieces displayed in the video image, playback from the recorded video image data being played back to the recorded video image data corresponding to the location information pieces selected by the user.

The embodiment is a video image display system including a terminal apparatus and a server apparatus, the server apparatus including: a recorded video image data receiving unit configured to receive recorded video image data, each being captured and transmitted by a plurality of vehicles, the recorded video image being a moving image outside the vehicle; a storage unit configured to store the recorded video image data, each being associated with time information and location information at which the recorded video image data is captured; and a recorded video image data providing unit configured to provide, to the terminal apparatus, recorded video image data that the terminal apparatus has requested to acquire, the terminal apparatus including: a recorded video image data acquisition unit configured to request a recorded video image data providing unit to acquire recorded video image data having time information in a predetermined time range and location information in a predetermined location range and acquire the recorded video image data; a display control unit configured to play back one of the acquired recorded video image data and have the display apparatus display the recorded video image data being played back and configured to display, in the video image of the recorded video image data being played back, location information of recorded video image data that is the acquired recorded video image data and other than the recorded video image data being played back so that a user can select the location information; and a playback switching processing unit configured to switch, when a user selects one of the location information pieces displayed in the video image, playback from the recorded video image data being played back to the recorded video image data corresponding to the location information pieces selected by the user.

The embodiment is a video image display method, the video image display method including: acquiring recorded video image data having time information in a predetermined time range and location information in a predetermined location range from among recorded video image data, each being captured by a plurality of vehicles, the recorded video image data being a moving image outside the vehicle; playing back one of the acquired recorded video image data and having the display apparatus display the recorded video image data being played back, and displaying, in the video image of the recorded video image data being played back, location information of recorded video image data that is the acquired recorded video image data and other than the recorded video image data being played back so that a user can select the location information; and switching, when a user selects one of the location information pieces displayed in the video image, playback from the recorded video image data being played back to the recorded video image data corresponding to the location information pieces selected by the user.

The embodiment is a program for displaying a video image, the program causing a computer to execute the following processing of: acquiring recorded video image data having time information in a predetermined time range and location information in a predetermined location range from among recorded video image data, each being captured by a plurality of vehicles, the recorded video image data being a moving image outside the vehicle; playing back one of the acquired recorded video image data and having the display apparatus display the recorded video image data being played back, and displaying, in the video image of the recorded video image data being played back, location information of recorded video image data that is the acquired recorded video image data and other than the recorded video image data being played back so that a user can select the location information; and switching, when a user selects one of the location information pieces displayed in the video image, playback from the recorded video image data being played back to the recorded video image data corresponding to the location information pieces selected by the user.

According to the embodiment, it is possible for a user to conveniently handle recorded video image data each captured by a plurality of vehicles in an integrated manner.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a schematic configuration of a video image display apparatus according to a first embodiment;

FIG. 2 shows an example of a playback video image in recorded video image data being played back;

FIG. 3 is a schematic diagram showing an example in which destination information is plotted with pins in the playback video image in the recorded video image data being played back;

FIG. 4 is a flowchart showing an example of a processing procedure for switching playback of the recorded video image data in the video image display apparatus according to the first embodiment; and

FIG. 5 is a block diagram showing a schematic configuration of the video image display apparatus according to a second embodiment.

### DETAILED DESCRIPTION

### First Embodiment

A first embodiment of the present invention is described hereinafter with reference to the drawings.

First, a schematic configuration of a video image display apparatus 10 according to this embodiment is described.

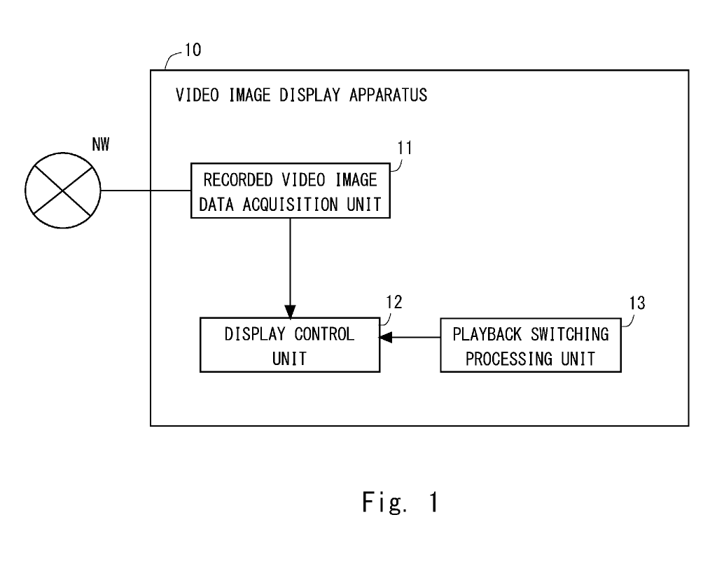

FIG. 1 is a block diagram showing the schematic configuration of the video image display apparatus 10. As shown in FIG. 1, the video image display apparatus 10 includes a recorded video image data acquisition unit 11, a display control unit 12, and a playback switching processing unit 13.

The video image display apparatus 10 is a terminal of various types capable of connecting to a service server through a communication network or the like, and is, for example, a personal computer, a mobile terminal, a game machine, and a television.

The recorded video image data acquisition unit 11 acquires recorded video image data having time information in a predetermined time range and location information in a predetermined location range from among recorded video image data, each being captured by a plurality of vehicles, the recorded video image data being a moving image outside the vehicle. A vehicle recording apparatus (e.g., a drive recorder) for capturing recorded video image data which is a moving image outside a vehicle is provided in each of the plurality of vehicles.

Video cameras, on which receiving units for receiving radio waves transmitted from a Global Positioning System (GPS) satellite are mounted, are installed in the drive recorders of the plurality of vehicles. Each of the video cameras captures a video image outside the vehicle. The video camera captures, for example, a road on which the preceding vehicle travels. A video camera suitable for capturing a moving image is used in this example, although a still camera having a moving image capturing function may instead be used.

Location information indicating a location of a point at which a traveling video image is captured and information on a time at which the traveling video image is acquired are added to recorded video image data captured by the drive recorder, the location information and the time information corresponding to the recorded video image data. It is preferred that the recorded video image data be uploaded to the service server in a state in which no audio is contained or the audio thereof be erased at the service server. Note that the location information is acquired by calculating the latitude and the longitude indicating a place where the own vehicle is located based on radio waves transmitted from the GPS satellite to the receiving unit of the drive recorder. Note that direction information indicating a direction in which the video camera (i.e., the vehicle) of the drive recorder faces may be added to the recorded video image data in addition to the location information and the time information. Further, the drive recorder may add Identification (ID) information to the recorded video image data in addition to the above information.

The recorded video image data to which the corresponding location information and time information are added is sequentially uploaded from the drive recorder to the service server and is transmitted from the service server to the recorded video image data acquisition unit 11. The recorded video image data acquisition unit 11 is connected to the service server through a communication line or a network NW. Note that the recorded video image data associated with the corresponding location information and time information may be directly transmitted to the recorded video image data acquisition unit 11 without communicating through the service server.

The display control unit 12 plays back one of the acquired recorded video image data and has the display apparatus display it, and plots, in the video image of the recorded video image data being played back, location information of recorded video image data which is the acquired recorded video image data and other than the recorded video image data being played back so that a user can select the location information. The service server may plot the location information of the recorded video image data other than the recorded video image data being played back and the display control unit 12 may play back the recorded video image data on which the location information is plotted. It is preferred that the recorded video image data acquisition unit 11 acquire recorded video image data from the service server and the display control unit 12 play back the recorded video image data by performing streaming playback from the service server.

The playback switching processing unit 13 switches, when a user selects one of the location information pieces plotted in the video image, playback from the recorded video image data being played back to the recorded video image data corresponding to the location information pieces selected by the user. That is, the playback switching processing unit 13 switches, when a user selects one of the location information pieces plotted in the video image, playback by requesting recorded video image data corresponding to the selected location information pieces from the service server.

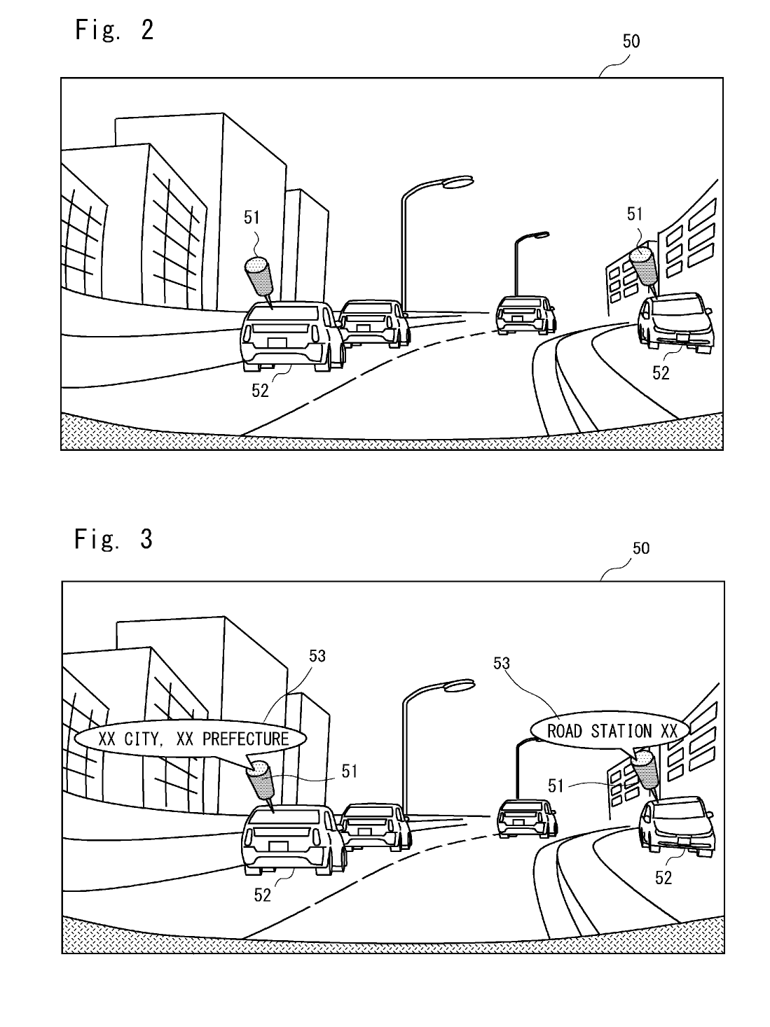

FIG. 2 shows an example of a playback video image in recorded video image data being played back. As shown in FIG. 2, in the playback video image in the recorded video image data being played back, a pin 51 is displayed by being superimposed thereon as a mark indicating location information of recorded video image data which is the acquired recorded video image data and other than the recorded video image data being played back. In other words, the latitude and the longitude in the area of the playback video image are recognized, and thus the location information (the latitude and the longitude) of recorded video image data which is the acquired recorded video image data and other than the recorded video image data being played back can be plotted in the area of the playback video image area using the pin 51. Note that an indication other than a pin, for example, any indication or expression such as an arrow can be applied to the mark indicating the location information of recorded video image data which is the acquired recorded video image data and other than the recorded video image data being played back.

When the pin 51 is plotted in the playback video image as described above, the pin 51 consequently indicates, among vehicles appearing in the area of the playback video image, the vehicle having recorded video image data to which time information of a predetermined time range and location information of a predetermined location range are added. Note that the location information plotted by the pin 51 in the playback video image may be limited to a predetermined range (i.e., a range less than 10 m in radius) from the locational information (the latitude and the longitude) of the recorded video image data being played back.

When direction information indicating a direction in which the video camera (i.e., the vehicle) of the drive recorder faces is added to the recorded video image data, the pin 51 may be plotted by limiting location information to that of the recorded video image data of which the direction information is opposite to that of the recorded video image data being played back. By doing so, other vehicles indicated by the pins 51 are limited to the vehicles facing the vehicle which has captured the recorded video image data being played back.

The pin 51 is plotted so that a user can select it. In other words, a user can select a specific pin 51, for example, by directly touching, with a finger, the pin 51 in the playback video image in the video image playback apparatus 10 (in this case, a touch-panel type display is used to display the recorded video image data) or by clicking it with a mouse pointer.

When a user selects the specific pin 51 in the playback video image, the playback switching processing unit 13 switches playback from the recorded video image data currently being played back to the recorded video image data corresponding to the location information selected by the user. That is, the user can virtually change the vehicle to another vehicle indicated by the pin 51 in the playback video image. Note that virtually changing the vehicle is switching playback from the recorded video image currently being played back to the recorded video image data of the other vehicle indicated by the pin 51. When the vehicle is virtually changed, the playback video image is switched to the recorded video image data selected by the user from the time at which the vehicle is virtually changed. As described above, the video image display apparatus 10 according to this embodiment can smoothly switch playback by only selecting the specific pin 51 in the playback video image, and thus it is convenient for a user to use it. This allows a user to enjoy virtually changing the vehicle as if he/she is playing a game.

Place name and facility information (destination information) of a location at the end of the recorded video image data, which place name and facility information correspond to the respective location information pieces plotted by the pin 51 in the playback video image, may be displayed in the vicinity of the respective location information pieces plotted in that playback video image. FIG. 3 is a schematic diagram showing an example in which destination information is plotted with the pins 51 in the playback video image in the recorded video image data being played back. As shown in FIG. 3, destination information 53, such as “XX city, XX prefecture” and “the road station XX”, are plotted in the vicinity of the location information plotted by the pins 51. This enables a user to confirm, in the playback video image, a route to the place where he/she wants to go.

Further, place name and facility information (passing point information) of a location in the middle of the recorded video image data, which place name and facility information correspond to the respective location information pieces plotted by the pin 51 in the playback video image, may be displayed in the vicinity of the respective location information pieces plotted in that playback video image. For example, information on the name of the place or the facility which vehicles have passed is plotted as location information indicating locations ahead of the locations indicated by the location information plotted by the pin 51 as shown in FIG. 3. The name of the place which the vehicles have passed is, for example, a city name which the vehicles subsequently pass in the recorded video image data corresponding to the location information plotted by the pin 51, a government ordinance-designated city, and a prefectural capital. Further, the name of the facility which the vehicles have passed is, for example, a well-known facility which the vehicles have passed the vicinity thereof in the recorded video image data corresponding to the location information plotted by the pin 51.

Further, a history of switching playback may be displayed in the playback video image so that a user can see how he/she has changed the vehicle so far, that is, how he/she has switched playback.

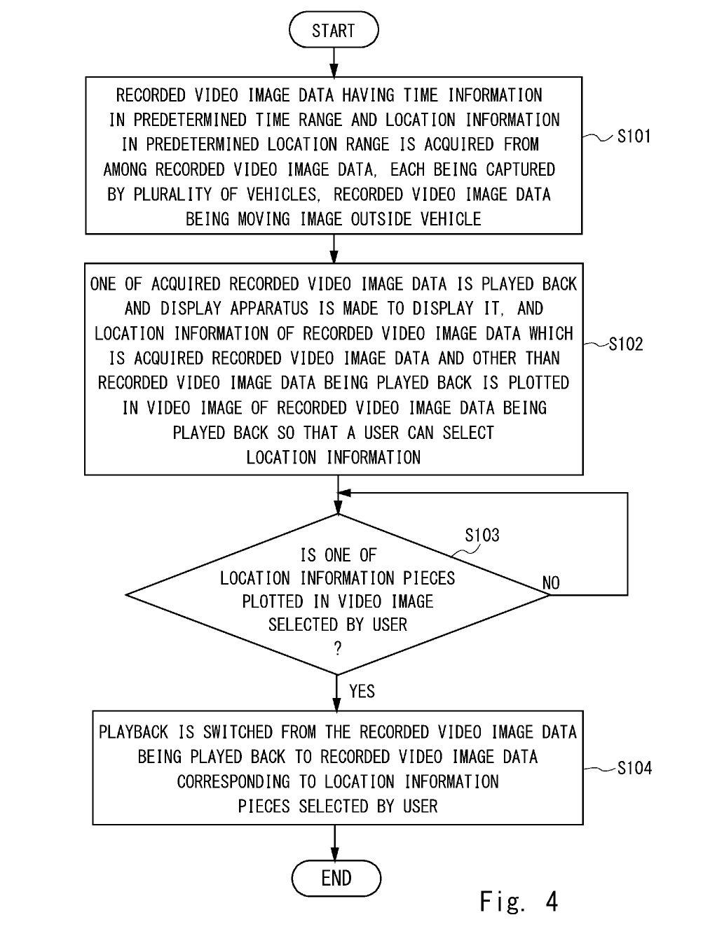

Next, a processing procedure for switching playback of the recorded video image data in the video image display apparatus 10 according to this embodiment is described with reference to FIG. 4. Note that as for the configuration of the video image display apparatus 10, FIG. 1 will be appropriately referred to in the following explanation.

FIG. 4 is a flowchart showing an example of the processing procedure for switching playback of the recorded video image data in the video image display apparatus 10. As shown in FIG. 4, first, recorded video image data having time information in a predetermined time range and location information in a predetermined location range is acquired from among recorded video image data, each being captured by a plurality of vehicles, the recorded video image data being a moving image outside the vehicle (Step S101). Following Step S101, one of the acquired recorded video image data is played back and the display apparatus is made to display it, and location information of recorded video image data which is the acquired recorded video image data and other than the recorded video image data being played back is plotted in the video image of the recorded video image data being played back so that a user can select the location information (Step S102).

As the recorded video image data firstly acquired in Step S101, the recorded video image data, which is recorded when the own vehicle specified by the own ID information travels, may be acquired selectively. Further, predetermined recorded video image data recorded when another vehicle travels may be selectively acquired. The selection of the recorded video image data may be made, for example, by specifying a predetermined date and time at a predetermined point on the map.

Next, it is determined whether one of the location information pieces plotted in the video image is selected by a user (Step S103). When one of the location information pieces plotted in the video image is selected by the user in Step S103 (YES in the Step), playback is switched from the recorded video image data being played back to the recorded video image data corresponding to the location information pieces selected by the user (Step S104).

As described above, the video image display apparatus 10 according to this embodiment can smoothly switch playback by only selecting the specific pin 51 in the playback video image and it is thus possible for a user to conveniently handle recorded video image data each captured by a plurality of vehicles in an integrated manner.

### Second Embodiment

A second embodiment of the present invention is described hereinafter with reference to the drawings. Note that the same parts as those in the first embodiment are denoted by the same symbols as those in the first embodiment and thus the explanations thereof are omitted.

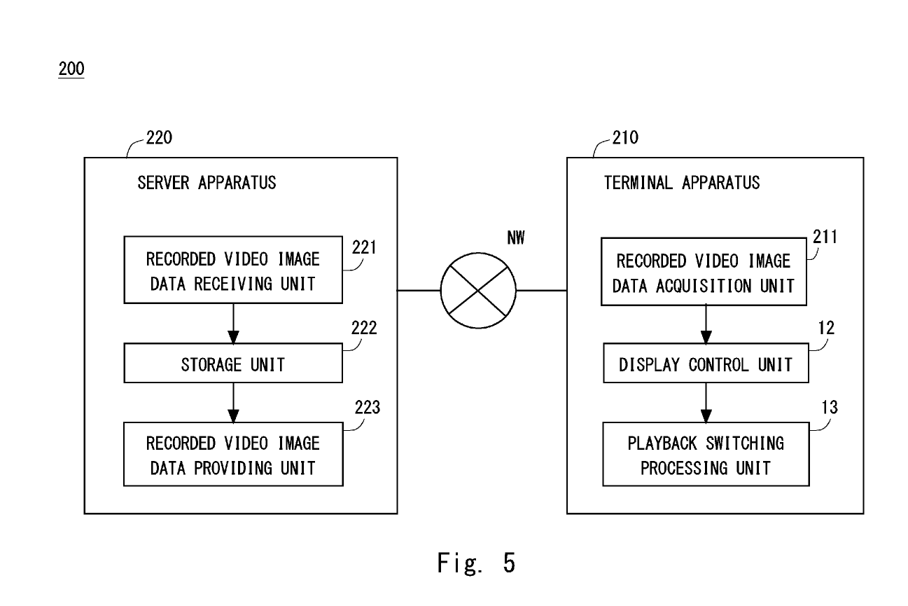

FIG. 5 is a block diagram showing a schematic configuration of a video image display apparatus 200 according to this embodiment. As shown in FIG. 5, the video image display system 200 according to this embodiment is composed of a server apparatus 220 and a terminal apparatus 210.

The server apparatus 220 includes a recorded video image data receiving unit 221, a storage unit 222, and a recorded video image data providing unit 223. The recorded video image data receiving unit 221 receives recorded video image data, each being captured and transmitted by a plurality of vehicles, the recorded video image data being a moving image outside the vehicle. The recorded video image data receiving unit 221 is connected to the communication line or the network NW in order to receive recorded video image data from a drive recorder of each of the vehicles. The storage unit 222 stores the recorded video image data received by the recorded video image data receiving unit 221, each being associated with time information and location information at which the recorded video image data is captured. The recorded image data providing unit 223 provides, to the terminal apparatus 210, the recorded video image data that the terminal apparatus 210 has requested to acquire. The recorded video image data providing unit 223 is connected to the communication line or the network NW in order to provide the recorded video image data to the terminal apparatus 210.

The terminal apparatus 210 includes a recorded video image data acquisition unit 211, the display control unit 12, and the playback switching processing unit 13. The terminal apparatus 210 is, for example, a personal computer, a mobile terminal, a game machine, and a television. The recorded video image data acquisition unit 211 requests the recorded video image data providing unit 223 to acquire recorded video image data having time information in a predetermined time range and location information in a predetermined location range and then acquires the recorded video image data. The recorded video image data acquisition unit 211 is connected to the server apparatus 220 through the communication line or the network NW.

The recorded video image data may be converted into a form containing no audio in the drive recorder of each of the vehicles and then transmitted to the server apparatus 220. Alternatively, the recorded video image data which contains audio and is transmitted from the drive recorder may be converted into a form containing no audio in the recording video image data providing unit 223 of the server apparatus 220 and then transmitted to the terminal apparatus 210.

The recorded video image data may be put, in the drive recorder of each of the vehicles, into a state where information specifying the vehicle (e.g., a license plate, a company name displayed on the door of the vehicle, or a passenger) and personal information such as a pedestrian and a nameplate outside a private residence cannot be determined in the drive recorder of each of the vehicles and then transmitted to the server apparatus 220. Alternatively, the recorded video image data may be put, in the recorded video image data providing unit 223 of the server apparatus 220, into a state where information specifying the vehicle and personal information such as a pedestrian and a nameplate outside a private residence cannot be determined in the drive recorder of each of the vehicles and then provided to the recorded video image data acquisition unit 11.

The terminal apparatus 210 first logs in the server apparatus 220 by connecting to the server apparatus 220 and collating its own ID information. The server apparatus 220 may provide, to the terminal apparatus 210 which has logged in, map data in which the location information of the recorded video image data stored in the storage unit 222 is added on the map. This map data is configured to enable a user to select location information of the recorded video image data displayed on the map.

In the terminal apparatus 210, a user specifies time information and selects a predetermined point on the map in the map data, and consequently the corresponding recorded video image data is played back. Note that a processing procedure for switching playback of the recorded data in the terminal apparatus 210 is the same as that in the video image display apparatus 10 according to the first embodiment which has been described using FIG. 4.

As described above, the video image display system according to this embodiment enables a user to conveniently handle recorded video image data each captured by a plurality of vehicles in an integrated manner.

Note that the present invention is not limited to the above-described embodiments, and various modifications can be made without departing from the scope of the invention.

The processing performed by each of the units of the video image display apparatus according to the present invention can be implemented by causing a computer or the like to execute a program. More specifically, in a vehicle display control apparatus, the processing is implemented by loading a program stored in the program memory into a main memory apparatus and executing the program under the control of the CPU. Note that the programs may be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a Compact Disc Read Only Memory (CD-ROM), CD-R, CD-R/W, and a semiconductor memory (such as a mask ROM, a Programmable ROM (PROM), an Erasable PROM (EPROM), a flash ROM, and a Random Access Memory (RAM)). The program may be supplied to computers by using various types of transitory computer readable media. Examples of the transitory computer readable media include an electrical signal, an optical signal, and an electromagnetic wave. The transitory computer readable media can be used to supply programs to a computer through a wired communication line (e.g., electric wires and optical fibers) or a wireless communication line. Further, the processing performed by each of the units of the vehicle display control apparatus is not necessarily implemented by software as a program but may be implemented by a combination of any hardware, firmware and software or the like.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

The first and second embodiments can be combined as desirable by one of ordinary skill in the art.

What is claimed is:

1. A video image display apparatus comprising:
a recorded video image data acquisition unit configured to acquire recorded video image data having time information in a predetermined time range and location information in a predetermined location range from among recorded video image data, each being captured by a plurality of vehicles, the recorded video image data being a moving image outside the vehicle;
a display control unit configured to play back one of the acquired recorded video image data and have the display apparatus display the recorded video image data being played back and configured to display, in the video image of the recorded video image data being played back, location information of recorded video image data that is the acquired recorded video image data and other than the recorded video image data being played back so that a user can select the location information and display, in the vicinity of the location information in the video image, information about a location ahead of the location indicated by the location information of the recorded video image data, the information corresponding to the respective location information pieces in the video image; and
a playback switching processing unit configured to switch, when a user selects one of the location information pieces displayed in the video image, playback from the recorded video image data being played back to the recorded video image data corresponding to the location information pieces selected by the user.

2. The video image display apparatus according to claim 1, wherein the display control unit displays, in the vicinity of the location information in the video image, destination information that is information about a location at the end of the recorded video image data is displayed in the vicinity of the respective location information pieces in the video image, the destination information corresponding to the respective location information pieces in the video image.

3. The video image display apparatus according to claim 1, wherein the display control unit displays, in the vicinity of the location information in the video image, passing point information that is information about a location ahead of the location indicated by the location information of the recorded video image data is displayed in the vicinity of the respective location information pieces in the video image, the passing point information corresponding to the respective location information pieces in the video image.

4. The video image display apparatus according to claim 1, wherein a history of switching playback is displayed in the video image of the recorded video image data being played back.

5. A video image display system comprising a terminal apparatus and a server apparatus,
the server apparatus comprising:
a recorded video image data receiving unit configured to receive recorded video image data, each being captured and transmitted by a plurality of vehicles, the recorded video image being a moving image outside the vehicle;
a storage unit configured to store the recorded video image data, each being associated with time information and location information at which the recorded video image data is captured; and
a recorded video image data providing unit configured to provide, to the terminal apparatus, recorded video image data that the terminal apparatus has requested to acquire,
the terminal apparatus comprising:
a recorded video image data acquisition unit configured to request a recorded video image data providing unit to acquire recorded video image data having time information in a predetermined time range and location information in a predetermined location range and acquire the recorded video image data;
a display control unit configured to play back one of the acquired recorded video image data and have the display apparatus display the recorded video image data being played back and configured to display, in the video image of the recorded video image data being played back, location information of recorded video image data that is the acquired recorded video image data and other than the recorded video image data being played back so that a user can select the location information and display, in the vicinity of the location information in the video image, information about a location ahead of the location indicated by the location information of the recorded video image data, the information corresponding to the respective location information pieces in the video image; and
a playback switching processing unit configured to switch, when a user selects one of the location information pieces displayed in the video image, playback from the recorded video image data being played back to the recorded video image data corresponding to the location information pieces selected by the user.

6. A video image display method comprising:
acquiring recorded video image data having time information in a predetermined time range and location information in a predetermined location range from among recorded video image data, each being captured by a plurality of vehicles, the recorded video image data being a moving image outside the vehicle;
playing back one of the acquired recorded video image data and having the display apparatus display the recorded video image data being played back, and displaying, in the video image of the recorded video image data being played back, location information of recorded video image data that is the acquired recorded video image data and other than the recorded video image data being played back so that a user can select the location information and displaying, in the vicinity of the location information in the video image, information about a location behind the location information of the recorded video image data, the information corresponding to the respective location information pieces in the video image; and
switching, when a user selects one of the location information pieces displayed in the video image, playback from the recorded video image data being played back to the recorded video image data corresponding to the location information pieces selected by the user.
